(19) United States
(12) Patent Application Publication
(10) Pub. No.: US 2022/0375469 A1
(43) Pub. Date: Nov. 24, 2022

(54) INTELLIGENT VOICE RECOGNITION METHOD AND APPARATUS

(71) Applicant: LG ELECTRONICS INC., Seoul (KR)

(72) Inventors: Yuseok YANG, Seoul (KR); Euihyeok LEE, Seoul (KR); Kihyeon KIM, Seoul (KR)

(73) Assignee: LG ELECTRONICS INC., Seoul (KR)

(21) Appl. No.: 17/773,528

(22) PCT Filed: Oct. 29, 2019
(86) PCT No.: PCT/KR2019/014332

§ 371 Date: Apr. 29, 2022

(51) Int. Cl. G10L 15/22; G10L 15/24

(52) U.S. Cl. CPC G10L 15/22; G10L 15/24; G10L 2015/225

(57) ABSTRACT

An intelligent voice recognition method and apparatus are disclosed. An intelligent voice recognition apparatus according to one embodiment of the present invention recognizes speech of the user and outputs a response determined on the basis of the speech, wherein, when a plurality of candidate responses related to the speech exist, the response is determined from among the plurality of candidate responses on the basis of device state information about the voice recognition apparatus, and thus ambiguity in a conversation between a user and the voice recognition apparatus can be reduced so that more natural conversation processing is possible. The intelligent voice recognition apparatus and/or an artificial intelligence (AI) apparatus of the present invention can be associated with an AI module, a drone (an unmanned aerial vehicle (UAV)), a robot, an augmented reality (AR) device, a virtual reality (VR) device, a device related to a 5G service, and the like.

### TECHNICAL FIELD

The present disclosure relates to an intelligent speech recognition method and device, more particularly, to an intelligent speech recognition method and device for authenticating users.

### BACKGROUND ART

A speech recognition device is a device that converts a user's speech into text, analyzes the meaning of a message contained in the text, and produces other forms of audio based on a result of analysis.

Examples of the speech recognition device may include a home robot in a home IoT system and an artificial intelligence (AI) speaker equipped with AI technology.

There are cases where the speech recognition device needs to recognize ambiguous utterances that can be recognized in several ways. The related art speech recognition device is inconvenient to ask the user about the meaning of the ambiguous utterance again.

### DISCLOSURE

### Technical Problem

An object of the present disclosure is to address the above-described and other problems.

Another object of the present disclosure is to implement an intelligent speech recognition method and device for accurately recognizing ambiguous utterances according to a situation.

### Technical Solution

In one aspect of the present disclosure, there is provided an intelligent speech recognition method comprises recognizing an utterance of a user; and outputting a response determined based on the recognized utterance, wherein based on there being a plurality of candidate responses related to the utterance, the response is determined among the plurality of candidate responses based on device status information of a speech recognition device.

Outputting the response may comprise determining whether there are the plurality of candidate responses related to the utterance, and based on there being the plurality of candidate responses related to the utterance, determining one response of the plurality of candidate responses based on the device status information of the speech recognition device, and determining whether there are the plurality of candidate responses may comprise determining whether a sentence included in the utterance is able to be processed in a plurality of applications, or the utterance is able to be processed in a plurality of motion statuses of the speech recognition device.

The device status information may include application identification information executed in the speech recognition device.

The device status information may include motion status information of the speech recognition device.

Outputting the response may comprise determining, as the response to be output, a first candidate response with a highest relation to the device status information of the speech recognition device among the plurality of candidate responses, and based on a specific feedback for the first candidate response being obtained from the user, determining, as the response to be output, a second candidate response with a highest relation to the device status information of the speech recognition device among remaining responses excluding the first candidate response from the plurality of candidate responses.

In another aspect of the present disclosure, there is provided an intelligent speech recognition device comprises at least one sensor; at least one speaker; at least one microphone; and a processor configured to recognize an utterance of a user obtained through the at least one microphone and output a response determined based on the recognized utterance through the at least one speaker, wherein the processor is configured to, based on there being a plurality of candidate responses related to the utterance, determine the response among the plurality of candidate responses based on device status information of the speech recognition device.

The processor may be further configured to determine whether there are the plurality of candidate responses related to the utterance, based on there being the plurality of candidate responses related to the utterance, determine one response of the plurality of candidate responses based on the device status information of the speech recognition device, and determine whether a sentence included in the utterance is able to be processed in a plurality of applications, or the utterance is able to be processed in a plurality of motion statuses of the speech recognition device.

The device status information may include application identification information executed in the speech recognition device.

The device status information may include motion status information of the speech recognition device obtained through the at least one sensor.

The processor may be further configured to determine, as the response to be output, a first candidate response with a highest relation to the device status information of the speech recognition device among the plurality of candidate responses, and based on a specific feedback for the first candidate response being obtained from the user, determine, as the response to be output, a second candidate response with a highest relation to the device status information of the speech recognition device among remaining responses excluding the first candidate response from the plurality of candidate responses.

### Advantageous Effects

Effects of an intelligent speech recognition method and device according to an embodiment of the present disclosure are described below.

The present disclosure can reduce ambiguity in conversation between a user and a speech recognition device and thus enables more natural conversation processing.

The present disclosure can actively respond to an ambiguous utterance of a user suitably for a situation in which the user has uttered.

The present disclosure can provide a speech recognition technology that is differentiated from virtual assistant services according to a related art, by reducing a step of having to ask a user again after an ambiguous utterance of the user.

The present disclosure can more flexibly respond to an ambiguous situation by learning an utterance pattern of the user, and can provide a speech recognition function customized for each user (individual).

Effects that could be achieved with the present disclosure are not limited to those that have been described hereinabove merely by way of example, and other effects and advantages of the present disclosure will be more clearly understood from the following description by a person skilled in the art to which the present disclosure pertains.

### DESCRIPTION OF DRAWINGS

The accompanying drawings, which are included to provide a further understanding of the present disclosure and constitute a part of the detailed description, illustrate embodiments of the present disclosure and serve to explain technical features of the present disclosure together with the description.

FIG. 1 illustrates an AI device 100 according to an embodiment of the present disclosure.

FIG. 2 illustrates an AI server 200 according to an embodiment of the present disclosure.

FIG. 3 illustrates an AI system 1 according to an embodiment of the present disclosure.

FIG. 4 illustrates an example of a schematic block diagram of a system in which a speech recognition method according to an embodiment of the present disclosure is implemented.

FIG. 5 is a block diagram of an AI device to which embodiments of the present disclosure are applicable.

FIG. 6 is a block diagram illustrating an example of a speech recognition device according to an embodiment of the present disclosure.

FIG. 7 illustrates a schematic block diagram of a speech recognition device in an environment of a speech recognition system according to an embodiment of the present disclosure.

FIG. 8 illustrates a schematic block diagram of a speech recognition device in an environment of a speech recognition system according to another embodiment of the present disclosure.

FIG. 9 illustrates a schematic block diagram of an AI processor capable of implementing speech recognition in accordance with an embodiment of the present disclosure.

FIG. 10 is a flow chart illustrating a speech recognition method according to an embodiment of the present disclosure.

FIG. 11 illustrates data flow in a speech recognition device according to an embodiment of the present disclosure.

FIG. 12 is a flow chart illustrating a response output process depending on an application type according to an embodiment of the present disclosure.

FIG. 13 is a flow chart illustrating a response output process depending on device movement status information according to an embodiment of the present disclosure.

### MODE FOR DISCLOSURE

Reference will now be made in detail to embodiments of the present disclosure, examples of which are illustrated in the accompanying drawings. Wherever possible, the same reference numbers will be used throughout the drawings to refer to the same or like parts. In general, a suffix such as “module” and “unit” may be used to refer to elements or components. Use of such a suffix herein is merely intended to facilitate description of the present disclosure, and the suffix itself is not intended to give any special meaning or function. It will be noted that a detailed description of known arts will be omitted if it is determined that the detailed description of the known arts can obscure the embodiments of the disclosure. The accompanying drawings are used to help easily understand various technical features and it should be understood that embodiments presented herein are not limited by the accompanying drawings. As such, the present disclosure should be construed to extend to any alterations, equivalents and substitutes in addition to those which are particularly set out in the accompanying drawings.

The terms including an ordinal number such as first, second, etc. may be used to describe various components, but the components are not limited by such terms. The terms are used only for the purpose of distinguishing one component from other components.

When any component is described as “being connected” or “being coupled” to other component, this should be understood to mean that another component may exist between them, although any component may be directly connected or coupled to the other component. In contrast, when any component is described as “being directly connected” or “being directly coupled” to other component, this should be understood to mean that no component exists between them.

A singular expression can include a plural expression as long as it does not have an apparently different meaning in context.

In the present disclosure, terms “include” and “have” should be understood to be intended to designate that illustrated features, numbers, steps, operations, components, parts or combinations thereof are present and not to preclude the existence of one or more different features, numbers, steps, operations, components, parts or combinations thereof, or the possibility of the addition thereof.

<Artificial Intelligence (AI)>

Artificial intelligence means the field in which artificial intelligence or methodology capable of producing artificial intelligence is researched. Machine learning means the field in which various problems handled in the artificial intelligence field are defined and methodology for solving the problems are researched. Machine learning is also defined as an algorithm for improving performance of a task through continuous experiences for the task.

An artificial neural network (ANN) is a model used in machine learning, and is configured with artificial neurons (nodes) forming a network through a combination of synapses, and may mean the entire model having a problem-solving ability. The artificial neural network may be defined by a connection pattern between the neurons of different layers, a learning process of updating a model parameter, and an activation function for generating an output value.

The artificial neural network may include an input layer, an output layer, and optionally one or more hidden layers. Each layer includes one or more neurons. The artificial neural network may include a synapse connecting neurons. In the artificial neural network, each neuron may output a function value of an activation function for input signals, weight, and a bias input through a synapse.

A model parameter means a parameter determined through learning, and includes the weight of a synapse connection and the bias of a neuron. Furthermore, a hyper parameter means a parameter that needs to be configured prior to learning in the machine learning algorithm, and includes a learning rate, the number of times of repetitions, a mini-deployment size, and an initialization function.

An object of the training of the artificial neural network may be considered to determine a model parameter that minimizes a loss function. The loss function may be used as an index for determining an optimal model parameter in the learning process of an artificial neural network.

Machine learning may be classified into supervised learning, unsupervised learning, and reinforcement learning based on a learning method.

Supervised learning means a method of training an artificial neural network in the state in which a label for learning data has been given. The label may mean an answer (or a result value) that must be deduced by an artificial neural network when learning data is input to the artificial neural network. Unsupervised learning may mean a method of training an artificial neural network in the state in which a label for learning data has not been given. Reinforcement learning may mean a learning method in which an agent defined within an environment is trained to select a behavior or behavior sequence that maximizes accumulated compensation in each state.

Machine learning implemented as a deep neural network (DNN) including a plurality of hidden layers, among artificial neural networks, is also called deep learning. Deep learning is part of machine learning. Hereinafter, machine learning is used as a meaning including deep learning.

<Robot>

A robot may mean a machine that automatically processes a given task or operates based on an autonomously owned ability. Particularly, a robot having a function for recognizing an environment and autonomously determining and performing an operation may be called an intelligence type robot.

A robot may be classified for industry, medical treatment, home, and military based on its use purpose or field.

A robot includes a driver including an actuator or motor, and may perform various physical operations, such as moving a robot joint. Furthermore, a movable robot includes a wheel, a brake, a propeller, etc. in a driver, and may run on the ground or fly in the air through the driver.

<Self-Driving (Autonomous-Driving)>

Self-driving means a technology for autonomous driving. An autonomous vehicle means a vehicle that runs without a user manipulation or by a user's minimum manipulation.

For example, self-driving may include all of a technology for maintaining a driving lane, a technology for automatically controlling speed, such as adaptive cruise control, a technology for automatic driving along a predetermined path, a technology for automatically configuring a path when a destination is set and driving.

A vehicle includes all of a vehicle having only an internal combustion engine, a hybrid vehicle including both an internal combustion engine and an electric motor, and an electric vehicle having only an electric motor, and may include a train, a motorcycle, etc. in addition to the vehicles.

In this case, the autonomous vehicle may be considered to be a robot having a self-driving function.

<eXtended Reality (XR)>

Extended reality collectively refers to virtual reality (VR), augmented reality (AR), and mixed reality (MR). The VR technology provides an object or background of the real world as a CG image only. The AR technology provides a virtually produced CG image on an actual thing image. The MR technology is a computer graphics technology for mixing and combining virtual objects with the real world and providing them.

The MR technology is similar to the AR technology in that it shows a real object and a virtual object. However, in the AR technology, a virtual object is used in a form to supplement a real object. In contrast, unlike in the AR technology, in the MR technology, a virtual object and a real object are used as the same character.

The XR technology may be applied to a head-mount display (HMD), a head-up display (HUD), a mobile phone, a tablet PC, a laptop, a desktop, TV, and a digital signage. A device to which the XR technology has been applied may be called an XR device.

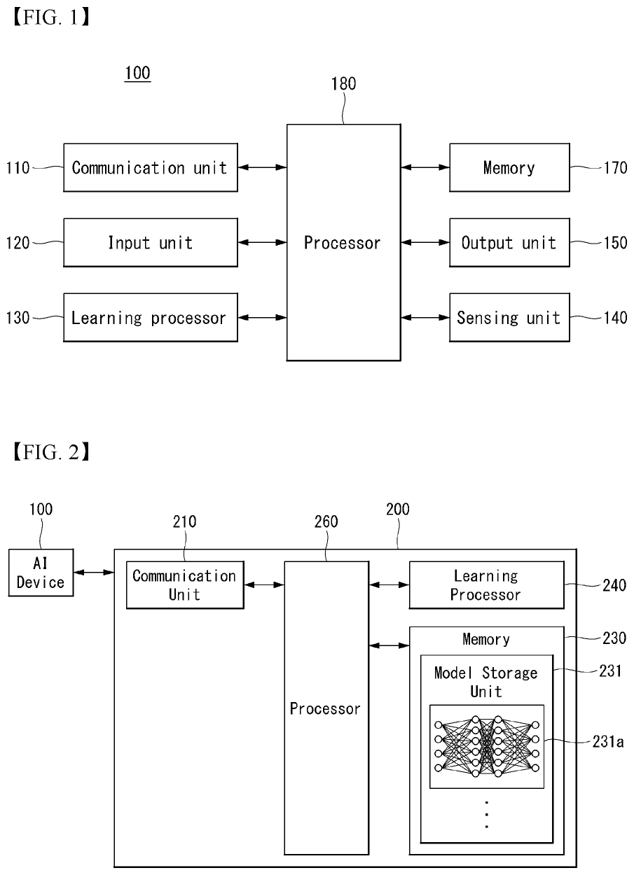

FIG. 1 illustrates an AI device 100 according to an embodiment of the present disclosure.

The AI device 100 may be implemented as a stationary device or mobile device, such as TV, a projector, a mobile phone, a smartphone, a desktop computer, a notebook, a terminal for digital broadcasting, a personal digital assistants (PDA), a portable multimedia player (PMP), a navigator, a tablet PC, a wearable device, a set-top box (STB), a DMB receiver, a radio, a washing machine, a refrigerator, a desktop computer, digital signage, a robot, and a vehicle.

Referring to FIG. 1, a terminal 100 may include a communication unit 110, an input unit 120, a learning processor 130, a sensing unit 140, an output unit 150, a memory 170 and a processor 180.

The communication unit 110 may transmit and receive data to and from external devices, such as other AI devices 100a to 100e or an AI server 200 using wired/wireless communication technologies. For example, the communication unit 110 may transmit and receive sensor information, user input, a learning model, or a control signal to and from external devices.

In this case, communication technologies used by the communication unit 110 include a global system for mobile communication (GSM), code division multi access (CDMA), long term evolution (LTE), 5G, a wireless LAN (WLAN), wireless-fidelity (Wi-Fi), Bluetooth™ radio frequency identification (RFID), infrared data association (IrDA), ZigBee, and near field communication (NFC).

The input unit 120 may obtain various types of data.

In this case, the input unit 120 may include a camera for an image signal input, a microphone for receiving an audio signal, a user input unit for receiving information from a user, etc. In this case, the camera or the microphone is treated as a sensor, and a signal obtained from the camera or the microphone may be called sensing data or sensor information.

The input unit 120 may obtain learning data for model learning and input data to be used when an output is obtained using a learning model. The input unit 120 may obtain not-processed input data. In this case, the processor 180 or the learning processor 130 may extract an input feature by performing pre-processing on the input data.

The learning processor 130 may be trained by a model configured with an artificial neural network using learning data. In this case, the trained artificial neural network may be called a learning model. The learning model is used to deduce a result value of new input data not learning data. The deduced value may be used as a base for performing a given operation.

In this case, the learning processor 130 may perform AI processing along with the learning processor 240 of the AI server 200.

In this case, the learning processor 130 may include memory integrated or implemented in the AI device 100. Alternatively, the learning processor 130 may be implemented using the memory 170, external memory directly coupled to the AI device 100 or memory maintained in an external device.

The sensing unit 140 may obtain at least one of internal information of the AI device 100, surrounding environment information of the AI device 100, or user information using various sensors.

In this case, sensors included in the sensing unit 140 include a proximity sensor, an illumination sensor, an acceleration sensor, a magnetic sensor, a gyro sensor, an inertia sensor, an RGB sensor, an IR sensor, a fingerprint recognition sensor, an ultrasonic sensor, a photo sensor, a microphone, a lidar, and a radar.

The output unit 150 may generate an output related to a visual sense, an auditory sense or a tactile sense.

In this case, the output unit 150 may include a display unit for outputting visual information, a speaker for outputting auditory information, and a haptic module for outputting tactile information.

The memory 170 may store data supporting various functions of the AI device 100. For example, the memory 170 may store input data obtained by the input unit 120, learning data, a learning model, a learning history, etc.

The processor 180 may determine at least one executable operation of the AI device 100 based on information, determined or generated using a data analysis algorithm or a machine learning algorithm. Furthermore, the processor 180 may perform the determined operation by controlling elements of the AI device 100.

To this end, the processor 180 may request, search, receive, and use the data of the learning processor 130 or the memory 170, and may control elements of the AI device 100 to execute a predicted operation or an operation determined to be preferred, among the at least one executable operation.

In this case, if association with an external device is necessary to perform the determined operation, the processor 180 may generate a control signal for controlling the corresponding external device and transmit the generated control signal to the corresponding external device.

The processor 180 may obtain intention information for a user input and transmit user requirements based on the obtained intention information.

In this case, the processor 180 may obtain the intention information, corresponding to the user input, using at least one of a speech-to-text (STT) engine for converting a speech input into a text string or a natural language processing (NLP) engine for obtaining intention information of a natural language.

In this case, at least some of at least one of the STT engine or the NLP engine may be configured as an artificial neural network trained based on a machine learning algorithm. Furthermore, at least one of the STT engine or the NLP engine may have been trained by the learning processor 130, may have been trained by the learning processor 240 of the AI server 200 or may have been trained by distributed processing thereof.

The processor 180 may collect history information including the operation contents of the AI device 100 or the feedback of a user for an operation, may store the history information in the memory 170 or the learning processor 130, or may transmit the history information to an external device, such as the AI server 200. The collected history information may be used to update a learning model.

The processor 180 may control at least some of the elements of the AI device 100 in order to execute an application program stored in the memory 170. Moreover, the processor 180 may combine and drive two or more of the elements included in the AI device 100 in order to execute the application program.

FIG. 2 illustrates an AI server 200 according to an embodiment of the present disclosure.

Referring to FIG. 2, the AI server 200 may mean an apparatus which trains an artificial neural network using a machine learning algorithm or which uses a trained artificial neural network. In this case, the AI server 200 is configured with a plurality of servers and may perform distributed processing and may be defined as a 5G network. In this case, the AI server 200 may be included as a partial configuration of the AI device 100, and may perform at least some of AI processing.

The AI server 200 may include a communication unit 210, memory 230, a learning processor 240 and a processor 260.

The communication unit 210 may transmit and receive data to and from an external device, such as the AI device 100.

The memory 230 may include a model storage unit 231. The model storage unit 231 may store a model (or artificial neural network 231a) which is being trained or has been trained through the learning processor 240.

The learning processor 240 may train the artificial neural network 231a using learning data. The learning model may be used in the state in which it has been mounted on the AI server 200 of the artificial neural network or may be mounted on an external device, such as the AI device 100, and used.

The learning model may be implemented as hardware, software or a combination of hardware and software. If some of or the entire learning model is implemented as software, one or more instructions configuring the learning model may be stored in the memory 230.

The processor 260 may deduce a result value of new input data using the learning model, and may generate a response or control command based on the deduced result value.

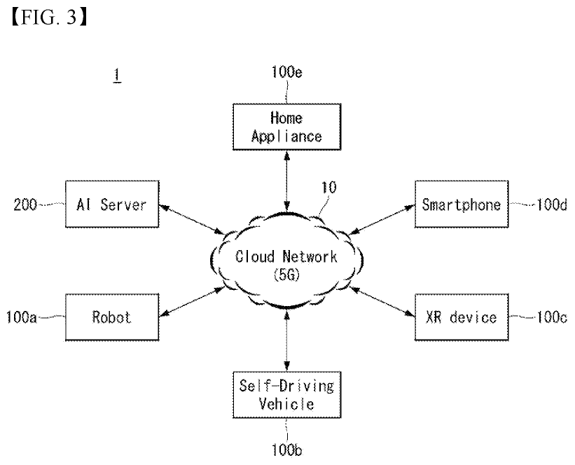

FIG. 3 illustrates an AI system 1 according to an embodiment of the present disclosure.

Referring to FIG. 3, an AI system 1 is connected to at least one of an AI server 200, a robot 100a, a self-driving vehicle 100b, an XR device 100c, a smartphone 100d or home appliances 100e over a cloud network 10. In this case, the robot 100a, the self-driving vehicle 100b, the XR device 100c, the smartphone 100d or the home appliances 100e to which the AI technology is applied may be called AI devices 100a to 100e.

The cloud network 10 may configure part of cloud computing infra or may mean a network present within cloud computing infra. In this case, the cloud network 10 may be configured using the 3G network, the 4G or long term evolution (LTE) network or the 5G network.

That is, the devices 100a to 100e and 200 constituting the AI system 1 may be interconnected over the cloud network 10. Particularly, the devices 100a to 100e and 200 may communicate with each other through a base station, but may directly communicate with each other without the intervention of a base station.

The AI server 200 may include a server for performing AI processing and a server for performing calculation on big data.

The AI server 200 is connected to at least one of the robot 100a, the self-driving vehicle 100b, the XR device 100c, the smartphone 100d or the home appliances 100e, that are AI devices constituting the AI system a, over the cloud network 10, and may help at least some of the AI processing of the connected AI devices 100a to 100e.

In this instance, the AI server 200 may train an artificial neural network based on a machine learning algorithm instead of the AI devices 100a to 100e, and may directly store a learning model or transmit the learning model to the AI devices 100a to 100e.

The AI server 200 may receive input data from the AI devices 100a to 100e, may deduce a result value of the received input data using the learning model, may generate a response or a control command based on the deduced result value, and may transmit the response or control command to the AI devices 100a to 100e.

Alternatively, the AI devices 100a to 100e may directly deduce a result value of input data using a learning model, and may generate a response or a control command based on the deduced result value.

Hereinafter, various embodiments of the AI devices 100a to 100e to which the above-described technology is applied are described. The AI devices 100a to 100e illustrated in FIG. 3 may be considered as specific implementations of the AI device 100 illustrated in FIG. 1.

<AI+Robot>

An AI technology is applied to the robot 100a, and the robot 100a may be implemented as a guide robot, a transport robot, a cleaning robot, a wearable robot, an entertainment robot, a pet robot, an unmanned flight robot, etc.

The robot 100a may include a robot control module for controlling an operation. The robot control module may mean a software module or a chip in which a software module is implemented using hardware.

The robot 100a may obtain state information of the robot 100a, may detect (recognize) a surrounding environment and object, may generate map data, may determine a moving path and a running plan, may determine a response to a user interaction, or may determine an operation using sensor information obtained from various types of sensors.

The robot 100a may use sensor information obtained by at least one sensor of a lidar, a radar, and a camera in order to determine the moving path and running plan.

The robot 100a may perform the above operations using a learning model configured with at least one artificial neural network. For example, the robot 100a may recognize a surrounding environment and object using a learning model, and may determine an operation using recognized surrounding environment information or object information. In this case, the learning model may be directly trained in the robot 100a or may be trained in an external device, such as the AI server 200.

In this instance, the robot 100a may directly generate results using the learning model and perform an operation, but may perform an operation by transmitting sensor information to an external device, such as the AI server 200, and receiving results generated in response thereto.

The robot 100a may determine a moving path and running plan using at least one of map data, object information detected from sensor information, or object information obtained from an external device. The robot 100a may run along the determined moving path and running plan by controlling the driver.

The map data may include object identification information for various objects disposed in the space in which the robot 100a moves. For example, the map data may include object identification information for fixed objects, such as a wall and a door, and movable objects, such as a flowerpot and a desk. Furthermore, the object identification information may include a name, a type, a distance, a location, etc.

Furthermore, the robot 100a may perform an operation or run by controlling the driver based on a user's control/interaction. In this case, the robot 100a may obtain intention information of an interaction according to a user's behavior or voice speaking, may determine a response based on the obtained intention information, and may perform an operation.

<AI+Self-Driving>

An AI technology is applied to the self-driving vehicle 100b, and the self-driving vehicle 100b may be implemented as a movable type robot, a vehicle, an unmanned flight body, etc.

The self-driving vehicle 100b may include a self-driving control module for controlling a self-driving function. The self-driving control module may mean a software module or a chip in which a software module has been implemented using hardware. The self-driving control module may be included in the self-driving vehicle 100b as an element of the self-driving vehicle 100b, but may be configured as separate hardware outside the self-driving vehicle 100b and connected to the self-driving vehicle 100b.

The self-driving vehicle 100b may obtain state information of the self-driving vehicle 100b, may detect (recognize) a surrounding environment and object, may generate map data, may determine a moving path and running plan, or may determine an operation using sensor information obtained from various types of sensors.

In this case, in order to determine the moving path and running plan, like the robot 100a, the self-driving vehicle 100b may use sensor information obtained from at least one sensor among LIDAR, a radar and a camera.

Particularly, the self-driving vehicle 100b may recognize an environment or object in an area whose view is blocked or an area of a given distance or more by receiving sensor information for the environment or object from external devices, or may directly receive recognized information for the environment or object from external devices.

The self-driving vehicle 100b may perform the above operations using a learning model configured with at least one artificial neural network. For example, the self-driving vehicle 100b may recognize a surrounding environment and object using a learning model, and may determine the flow of running using recognized surrounding environment information or object information. In this case, the learning model may have been directly trained in the self-driving vehicle 100b or may have been trained in an external device, such as the AI server 200.

In this instance, the robot 100a may directly generate results using the learning model and perform an operation, but may perform an operation by transmitting sensor information to an external device, such as the AI server 200, and receiving results generated in response thereto.

The robot 100a may determine a moving path and a running plan using at least one of map data, object information detected from sensor information or object information obtained from an external device. The robot 100a may run based on the moving path and running plan determined by controlling the driver.

The map data may include object identification information for various objects disposed in the space in which the robot 100a moves. For example, the map data may include object identification information for fixed objects, such as a wall and a door, and movable objects, such as a flowerpot and a desk. Furthermore, the object identification information may include a name, a type, a distance, a location, etc.

Furthermore, the robot 100a may perform an operation or run by controlling the driver based on a user's control/interaction. In this instance, the robot 100a may obtain intention information of an interaction according to a user's behavior or speech utterance, may determine a response based on the obtained intention information, and may perform an operation.

<AI+Self-Driving>

An AI technology is applied to the self-driving vehicle 100b, and the self-driving vehicle 100b may be implemented as a movable type robot, a vehicle, an unmanned flight body, etc.

The self-driving vehicle 100b may include a self-driving control module for controlling a self-driving function. The self-driving control module may mean a software module or a chip in which a software module has been implemented using hardware. The self-driving control module may be included in the self-driving vehicle 100b as an element of the self-driving vehicle 100b, but may be configured as separate hardware outside the self-driving vehicle 100b and connected to the self-driving vehicle 100b.

The self-driving vehicle 100b may obtain state information of the self-driving vehicle 100b, may detect (recognize) a surrounding environment and object, may generate map data, may determine a moving path and running plan, or may determine an operation using sensor information obtained from various types of sensors.

In this case, in order to determine the moving path and running plan, like the robot 100a, the self-driving vehicle 100b may use sensor information obtained from at least one sensor among LIDAR, a radar and a camera.

Particularly, the self-driving vehicle 100b may recognize an environment or object in an area whose view is blocked or an area of a given distance or more by receiving sensor information for the environment or object from external devices, or may directly receive recognized information for the environment or object from external devices.

The self-driving vehicle 100b may perform the above operations using a learning model configured with at least one artificial neural network. For example, the self-driving vehicle 100b may recognize a surrounding environment and object using a learning model, and may determine the flow of running using recognized surrounding environment information or object information. In this case, the learning model may have been directly trained in the self-driving vehicle 100b or may have been trained in an external device, such as the AI server 16.

In this case, the self-driving vehicle 100b may directly generate results using the learning model and perform an operation, but may perform an operation by transmitting sensor information to an external device, such as the AI server 16, and receiving results generated in response thereto.

The self-driving vehicle 100b may determine a moving path and running plan using at least one of map data, object information detected from sensor information or object information obtained from an external device. The self-driving vehicle 100b may run based on the determined moving path and running plan by controlling the driver.

The map data may include object identification information for various objects disposed in the space (e.g., road) in which the self-driving vehicle 100b runs. For example, the map data may include object identification information for fixed objects, such as a streetlight, a rock, and a building, etc., and movable objects, such as a vehicle and a pedestrian. Furthermore, the object identification information may include a name, a type, a distance, a location, etc.

Furthermore, the self-driving vehicle 100b may perform an operation or may run by controlling the driver based on a user's control/interaction. In this case, the self-driving vehicle 100b may obtain intention information of an interaction according to a user' behavior or voice speaking, may determine a response based on the obtained intention information, and may perform an operation.

<AI+XR>

An AI technology is applied to the XR device 100c, and the XR device 100c may be implemented as a head-mount display, a head-up display provided in a vehicle, television, a mobile phone, a smartphone, a computer, a wearable device, home appliances, a digital signage, a vehicle, a fixed type robot or a movable type robot.

The XR device 100c may generate location data and attributes data for three-dimensional points by analyzing three-dimensional point cloud data or image data obtained through various sensors or from an external device, may obtain information on a surrounding space or real object based on the generated location data and attributes data, and may output an XR object by rendering the XR object. For example, the XR device 100c may output an XR object, including additional information for a recognized object, by making the XR object correspond to the corresponding recognized object.

The XR device 100c may perform the above operations using a learning model configured with at least one artificial neural network. For example, the XR device 100c may recognize a real object in three-dimensional point cloud data or image data using a learning model, and may provide information corresponding to the recognized real object. In this case, the learning model may have been directly trained in the XR device 100c or may have been trained in an external device, such as the AI server 200.

In this case, the XR device 100c may directly generate results using a learning model and perform an operation, but may perform an operation by transmitting sensor information to an external device, such as the AI server 200, and receiving results generated in response thereto.

<AI+Robot+Self-Driving>

An AI technology and a self-driving technology are applied to the robot 100a, and the robot 100a may be implemented as a guide robot, a transport robot, a cleaning robot, a wearable robot, an entertainment robot, a pet robot, an unmanned flight robot, etc.

The robot 100a to which the AI technology and the self-driving technology have been applied may mean a robot itself having a self-driving function or may mean the robot 100a interacting with the self-driving vehicle 100b.

The robot 100a having the self-driving function may collectively refer to devices that autonomously move along a given flow without control of a user or autonomously determine a flow and move.

The robot 100a and the self-driving vehicle 100b having the self-driving function may use a common sensing method in order to determine one or more of a moving path or a running plan. For example, the robot 100a and the self-driving vehicle 100b having the self-driving function may determine one or more of a moving path or a running plan using information sensed through LIDAR, a radar, a camera, etc.

The robot 100a interacting with the self-driving vehicle 100b is present separately from the self-driving vehicle 100b, and may perform an operation associated with a self-driving function inside or outside the self-driving vehicle 100b or associated with a user got in the self-driving vehicle 100b.

In this case, the robot 100a interacting with the self-driving vehicle 100b may control or assist the self-driving function of the self-driving vehicle 100b by obtaining sensor information in place of the self-driving vehicle 100b and providing the sensor information to the self-driving vehicle 100b, or by obtaining sensor information, generating surrounding environment information or object information, and providing the surrounding environment information or object information to the self-driving vehicle 100b.

Alternatively, the robot 100a interacting with the self-driving vehicle 100b may control the function of the self-driving vehicle 100b by monitoring a user got in the self-driving vehicle 100b or through an interaction with a user. For example, if a driver is determined to be a drowsiness state, the robot 100a may activate the self-driving function of the self-driving vehicle 100b or assist control of the driver of the self-driving vehicle 100b. In this case, the function of the self-driving vehicle 100b controlled by the robot 100a may include a function provided by a navigation system or audio system provided within the self-driving vehicle 100b, in addition to a self-driving function simply.

Alternatively, the robot 100a interacting with the self-driving vehicle 100b may provide information to the self-driving vehicle 100b or may assist a function outside the self-driving vehicle 100b. For example, the robot 100a may provide the self-driving vehicle 100b with traffic information, including signal information, as in a smart traffic light, and may automatically connect an electric charger to a filling inlet through an interaction with the self-driving vehicle 100b as in the automatic electric charger of an electric vehicle.

<AI+Robot+XR>

An AI technology and an XR technology are applied to the robot 100a, and the robot 100a may be implemented as a guide robot, a transport robot, a cleaning robot, a wearable robot, an entertainment robot, a pet robot, an unmanned flight robot, a drone, etc.

The robot 100a to which the XR technology has been applied may mean a robot, that is, a target of control/interaction within an XR image. In this case, the robot 100a is different from the XR device 100c, and they may operate in conjunction with each other.

When the robot 100a, that is, a target of control/interaction within an XR image, obtains sensor information from sensors including a camera, the robot 100a or the XR device 100c may generate an XR image based on the sensor information, and the XR device 100c may output the generated XR image. Furthermore, the robot 100a may operate based on a control signal received through the XR device 100c or a user's interaction.

For example, a user may identify a corresponding XR image at timing of the robot 100a, remotely operating in conjunction through an external device, such as the XR device 100c, may adjust the self-driving path of the robot 100a through an interaction, may control an operation or driving, or may identify information of a surrounding object.

<AI+Self-Driving+XR>

An AI technology and an XR technology are applied to the self-driving vehicle 100b, and the self-driving vehicle 100b may be implemented as a movable type robot, a vehicle, an unmanned flight body, etc.

The self-driving vehicle 100b to which the XR technology has been applied may mean a self-driving vehicle equipped with means for providing an XR image or a self-driving vehicle, that is, a target of control/interaction within an XR image. Particularly, the self-driving vehicle 100b, that is, a target of control/interaction within an XR image, is different from the XR device 100c, and they may operate in conjunction with each other.

The self-driving vehicle 100b equipped with the means for providing an XR image may obtain sensor information from sensors including a camera, and may output an XR image generated based on the obtained sensor information. For example, the self-driving vehicle 100b includes an HUD, and may provide a passenger with an XR object corresponding to a real object or an object within a screen by outputting an XR image.

In this case, when the XR object is output to the HUD, at least some of the XR object may be output with it overlapping a real object toward which a passenger's view is directed. In contrast, when the XR object is displayed on a display included within the self-driving vehicle 100b, at least some of the XR object may be output so that it overlaps an object within a screen. For example, the self-driving vehicle 100b may output XR objects corresponding to objects, such as a carriageway, another vehicle, a traffic light, a signpost, a two-wheeled vehicle, a pedestrian, and a building.

When the self-driving vehicle 100b, that is, a target of control/interaction within an XR image, obtains sensor information from sensors including a camera, the self-driving vehicle 100b or the XR device 100c may generate an XR image based on the sensor information. The XR device 100c may output the generated XR image. Furthermore, the self-driving vehicle 100b may operate based on a control signal received through an external device, such as the XR device 100c, or a user's interaction.

H. Speech Recognition System and AI Processing

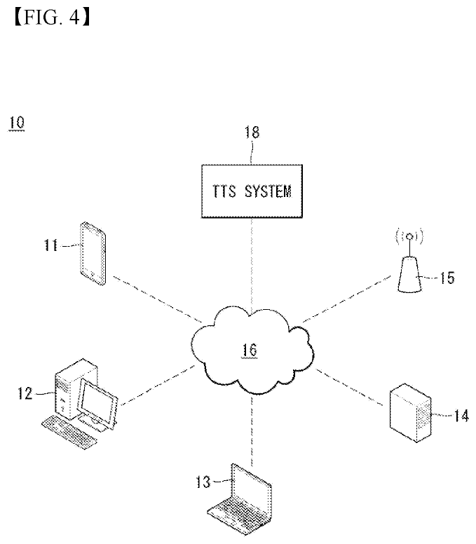

FIG. 4 illustrates an example of a schematic block diagram of a system in which a speech recognition method according to an embodiment of the present disclosure is implemented.

Referring to FIG. 4, a system in which a speech recognition method according to an embodiment of the present disclosure is implemented may include a speech recognition device 10, a network system 16, and a text-to-speech (TTS) system 18 as a speech synthesis engine.

At least one speech recognition device 10 may include a mobile phone 11, a PC 12, a notebook computer 13, and other server devices 14. The PC 12 and the notebook computer 13 may be connected to at least one network system 16 via a wireless access point 15. According to an embodiment of the present disclosure, the speech recognition device 10 may include an audio book and a smart speaker.

The TTS system 18 may be implemented in a server included in a network, or may be implemented by on-device processing and embedded in the speech recognition device 10. In an embodiment of the present disclosure, it is assumed that the TTS system 18 is embedded and implemented in the speech recognition device 10.

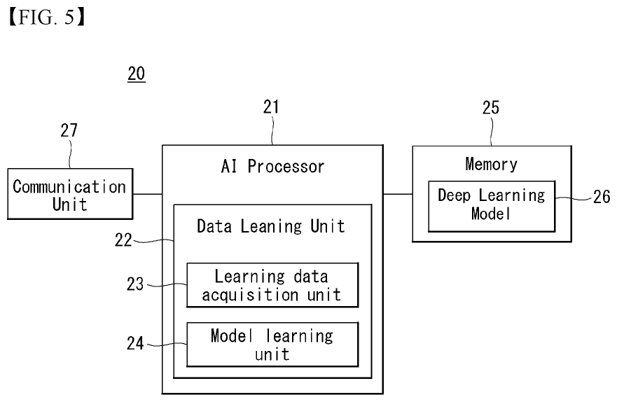

FIG. 5 is a block diagram of an AI device to which embodiments of the present disclosure are applicable.

An AI device 20 may include an electronic device including an AI module capable of performing AI processing, or a server including the AI module, and the like. The AI device 20 may be included as at least a partial configuration of the speech recognition device 10 illustrated in FIG. 4 to perform at least a part of the AI processing.

The AI processing may include all the operations related to the speech recognition of the speech recognition device 10 illustrated in FIG. 5. For example, the AI processing may be a process of analyzing data obtained through an input unit of the speech recognition device 10 and recognizing new data.

The AI device 20 may include an AI processor 21, a memory 25, and/or a communication unit 27.

The AI device 20 is a computing device capable of learning a neural network and may be implemented as various electronic devices such as a server, a desktop PC, a notebook PC, and a tablet PC.

The AI processor 21 may learn a neural network using a program stored in the memory 25.

In particular, the AI processor 21 may train a neural network for recognizing new data by analyzing data obtained through the input unit. The neural network for recognizing data may be designed to emulate a human brain structure on a computer and may include a plurality of network nodes with weights that emulate neurons in a human neural network.

The plurality of network nodes may send and receive data according to each connection relationship so that neurons emulate the synaptic activity of neurons sending and receiving signals through synapses. Herein, the neural network may include a deep learning model which has evolved from a neural network model. In the deep learning model, a plurality of network nodes may be arranged in different layers and may send and receive data according to a convolution connection relationship. Examples of the neural network model may include various deep learning techniques, such as deep neural networks (DNN), convolutional deep neural networks (CNN), recurrent Boltzmann machine (RNN), restricted Boltzmann machine (RBM), deep belief networks (DBN), and deep Q-networks, and are applicable to fields including computer vision, voice recognition, natural language processing, and voice/signal processing, etc.

A processor performing the above-described functions may be a general purpose processor (e.g., CPU), but may be AI-dedicated processor (e.g., GPU) for AI learning.

The memory 25 may store various programs and data required for the operation of the AI device 20. The memory 25 may be implemented as a non-volatile memory, a volatile memory, a flash memory, a hard disk drive (HDD), or a solid state drive (SSD), etc. The memory 25 may be accessed by the AI processor 21, and the AI processor 21 may read/write/modify/delete/update data. Further, the memory 25 may store a neural network model (e.g., deep learning model 26) created by a learning algorithm for data classification/recognition according to an embodiment of the present disclosure.

The AI processor 21 may further include a data learning unit 22 for learning a neural network for data classification/recognition. The data learning unit 22 may learn criteria as to which learning data is used to determine the data classification/recognition and how to classify and recognize data using learning data. The data learning unit 22 may learn a deep learning model by acquiring learning data to be used in the learning and applying the acquired learning data to the deep learning model.

The data learning unit 22 may be manufactured in the form of at least one hardware chip and mounted on the AI device 20. For example, the data learning unit 22 may be manufactured in the form of a dedicated hardware chip for artificial intelligence (AI), or may be manufactured as a part of a general purpose processor (e.g., CPU) or a graphic-dedicated processor (e.g., GPU) and mounted on the AI device 20. Further, the data learning unit 22 may be implemented as a software module. If the data learning unit 22 is implemented as the software module (or a program module including instruction), the software module may be stored in non-transitory computer readable media. In this case, at least one software module may be provided by an operating system (OS), or provided by an application.

The data learning unit 22 may include a learning data acquisition unit 23 and a model learning unit 24.

The learning data acquisition unit 23 may acquire learning data required for a neural network model for classifying and recognizing data. For example, the learning data acquisition unit 23 may acquire, as learning data, data to be input to a neural network model and/or feature values extracted from the data.

By using the acquired learning data, the model learning unit 24 may learn so that the neural network model has a criteria for determining how to classify predetermined data. In this instance, the model learning unit 24 may train the neural network model through supervised learning which uses at least a part of the learning data as the criteria for determination. Alternatively, the model learning unit 24 may train the neural network model through unsupervised learning which finds criteria for determination by allowing the neural network model to learn on its own using the learning data without supervision. Further, the model learning unit 24 may train the neural network model through reinforcement learning using feedback about whether a right decision is made on a situation by learning. Further, the model learning unit 24 may train the neural network model using a learning algorithm including error back-propagation or gradient descent.

If the neural network model is trained, the model learning unit 24 may store the trained neural network model in the memory. The model learning unit 24 may store the trained neural network model in a memory of a server connected to the AI device 20 over a wired or wireless network.

The data learning unit 22 may further include a learning data pre-processing unit (not shown) and a learning data selection unit (not shown), in order to improve a result of analysis of a recognition model or save resources or time required to create the recognition model.

The learning data pre-processing unit may pre-process acquired data so that the acquired data can be used in learning for recognizing new data. For example, the learning data pre-processing unit may process acquired learning data into a predetermined format so that the model learning unit 24 can use the acquired learning data in learning for recognizing new data.

Moreover, the learning data selection unit may select data required for learning among learning data acquired by the learning data acquisition unit 23 or learning data pre-processed by the pre-processing unit. The selected learning data may be provided to the model learning unit 24. For example, the learning data selection unit may detect a specific area among feature values of data acquired by the speech recognition device 10 to select, as learning data, only data for syllable included in the specific area.

In addition, the data learning unit 22 may further include a model evaluation unit (not shown) for improving the result of analysis of the neural network model.

The model evaluation unit may input evaluation data to the neural network model and may allow the model learning unit 22 to learn the neural network model again if a result of analysis output from the evaluation data does not satisfy a predetermined criterion. In this case, the evaluation data may be data that is pre-defined for evaluating the recognition model. For example, if the number or a proportion of evaluation data with inaccurate analysis result among analysis results of the recognition model learned on the evaluation data exceeds a predetermined threshold, the model evaluation unit may evaluate the analysis result as not satisfying the predetermined criterion.

The communication unit 27 may send an external electronic device a result of the AI processing by the AI processor 21.

If the AI processor 21 is included in a network system, the external electronic device may be a speech recognition device according to an embodiment of the present disclosure.

Although the AI device 20 illustrated in FIG. 5 is described such that it is functionally separated into the AI processor 21, the memory 25, the communication unit 27, etc., the above components may be integrated into one module and may be referred to as an AI module.

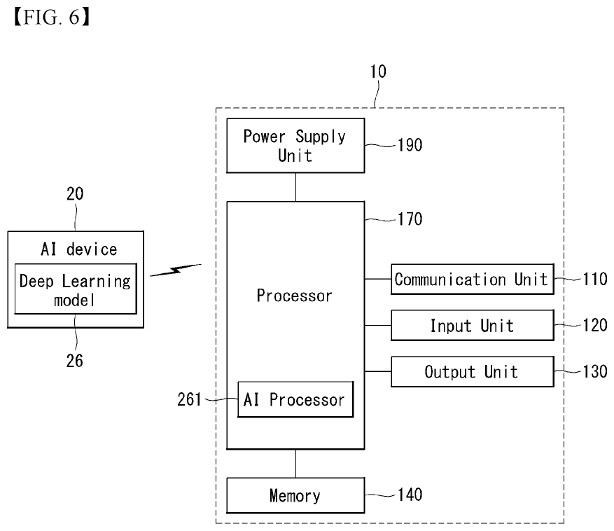

FIG. 6 is a block diagram illustrating an example of a speech recognition device according to an embodiment of the present disclosure.

An embodiment of the present disclosure may include computer-readable and computer-executable instructions that may be included in the speech recognition device 10. FIG. 6 illustrates a plurality of components included in the speech recognition device 10 merely by way of example, and it is obvious that components that are not illustrated in FIG. 6 can be included in the speech recognition device 10.

A plurality of speech recognition devices may also be applied to one speech recognition device. In such a multi-device system, the speech recognition device may include different components for performing various aspects of speech recognition processing. The speech recognition device 10 illustrated in FIG. 6 is merely an example, and may be an independent device or implemented as one component of a larger device or system.

An embodiment of the present disclosure may be applied to a plurality of different devices and computer systems, for example, a general purpose computing system, a server-client computing system, a telephone computing system, a laptop computer, a mobile terminal, a PDA, a tablet computer, etc. The speech recognition device 10 may also be applied as one component of other devices or systems that provide a speech recognition function, for example, automated teller machines (ATMs), kiosks, global positioning systems (GPSs), home appliances (e.g., refrigerators, ovens, washing machines, etc.), vehicles, and e-book readers.

As illustrated in FIG. 6, the speech recognition device 10 may include a communication unit 110, an input unit 120, an output unit 130, a memory 140, a power supply unit 190, and/or a processor 170. Some of the components disclosed in the speech recognition device 10 may be a single component and may appear multiple times in one device.

The speech recognition device 10 may include an address/data bus (not shown) for transmitting data to the components of the speech recognition device 10. The respective components in the speech recognition device 10 may be directly connected to other components via the bus (not shown). The respective components in the speech recognition device 10 may be directly connected to the processor 170.

The communication unit 110 may include a wireless communication device such as radio frequency (RF), infrared, Bluetooth, and wireless local area network (WLAN) (Wi-Fi, etc.), or a wireless network device such as 5G network, long term evolution (LTE) network, WiMAN network, and 3G network.

The input unit 120 may include a microphone, a touch input unit, a keyboard, a mouse, a stylus, or other input units.

The output unit 130 may output information (e.g., speech) processed by the speech recognition device 10 or other devices. The output unit 130 may include a speaker, a headphone, or other appropriate components that propagate speech. For another example, the output unit 130 may include an audio output unit. Further, the output unit 130 may include a display (visual display or tactile display), an audio speaker, a headphone, a printer, or other output units. The output unit 130 may be integrated in the speech recognition device 10, or may be implemented separately from the speech recognition device 10.

The input unit 120 and/or the output unit 130 may include an interface for connecting external peripherals, such as a universal serial bus (USB), FireWire, thunderbolt, or other connection protocols. The input unit 120 and/or the output unit 130 may include a network connection such as an Ethernet port, modem port, etc. The speech recognition device 10 may be connected to internet or a distributed computing environment through the input unit 120 and/or the output unit 130. Further, the speech recognition device 10 may be connected to a removable or external memory (e.g., a removable memory card, memory key drive, network storage, etc.) through the input unit 120 and/or the output unit 130.

The memory 140 may store data and instructions. The memory 140 may include a magnetic storage, an optical storage, a solid-state storage, etc. The memory 140 may include a volatile RAM, a non-volatile ROM, or other memories.

The speech recognition device 10 may include a processor 170. The processor 170 may be connected to the bus (not shown), the input unit 120, the output unit 130, and/or other components of the speech recognition device 10. The processor 170 may correspond to a data processing CPU or a data processing memory for storing computer-readable instructions and data.

Computer instructions to be processed by the processor 170 for running the speech recognition device 10 and its various components may be executed by the processor 170, or stored in the memory 140, an external device, or a memory or storage included in the processor 170 to be described later. Alternatively, all or some of the executable instructions may be added to software and embedded in hardware or firmware. An embodiment of the present disclosure may be implemented by, for example, a variety of combinations of software, firmware, and/or hardware.

Specifically, the processor 170 may process textual data into an audio waveform containing voice or process an audio waveform into textual data. Textual data may originate from an internal component of the voice recognizing apparatus 10. Also, the textual data may be received from an input unit such as a keyboard or may be sent to the voice recognizing apparatus 10 via a network connection. Text may take the form of a sentence including text, numbers, and/or punctuation for conversion into voice by the processor 170. Input text may comprise special annotations for processing by the processor 170. The special annotations may indicate how particular text is to be pronounced. The textual data may be processed in real time or may be stored and processed at a later time.

Although not shown in FIG. 6, the processor 170 may include a front end, a speech synthesis engine, and a TTS storage. The front end may transform input text data into a symbolic linguistic representation for processing by the speech synthesis engine. The speech synthesis engine may transform input text into speech by comparing annotated phonetic unit models and information stored in the TTS storage. The front end and the speech synthesis engine may comprise an internal embedded processor or memory, or may use the processor 170 or memory 140 included in the voice recognizing apparatus 10. Instructions for running the front end and speech synthesis engine may be included in the processor 170, the memory 140 of the voice recognizing apparatus 10, or an external device.

Text input into the processor 170 may be transmitted to the front end for processing. The front end may comprise a module for performing text normalization, linguistic analysis, and linguistic prosody generation.

During text normalization, the front end processes the text input, generates standard text, and converts numbers, abbreviations, and symbols into the equivalent of written-out words.

During linguistic analysis, the front end may generate a sequence of phonetic units corresponding to the input text by analyzing the language in the normalized text. This process may be called phonetic transcription.

Phonetic units include symbolic representations of sound units to be eventually combined and output by the voice recognizing apparatus 10 as voice (speech). Various sound units may be used for dividing text for the purpose of speech synthesis.

The processor 170 may process speech based on phonemes (individual sounds), half-phonemes, di-phones (the last half of one phoneme coupled with the first half of the adjacent phoneme), bi-phones (two consecutive phonemes), syllables, words, phrases, sentences, or other units. Each word may be mapped to one or more phonetic units. Such mapping may be performed using a language dictionary stored in the voice recognizing apparatus 10.

The linguistic analysis performed by the front end may comprise a process of identifying different grammatical components such as prefixes, suffixes, phrases, punctuation, syntactic boundaries, or the like. Such grammatical components may be used by the processor 170 to craft a natural sounding audio waveform output. The language dictionary may also include letter-to-sound rules and other tools that may be used to pronounce previously unidentified words or letter combinations that may be encountered by the processor 170. Generally, the more the information included in the language dictionary, the higher the quality of speech output.

Based on the linguistic analysis, the front end may then perform linguistic prosody generation where the phonetic units are annotated with desired prosodic characteristics which indicate how the desired phonetic units are to be pronounced in the eventual output speech.

The prosodic characteristics are also called acoustic features. During this stage, the front end may consider and incorporate any prosodic annotations accompanying the text input to the processor 170. Such acoustic features may include pitch, energy, duration, and the like. Application of acoustic features may be based on prosodic models available to the processor 170.

Such prosodic models indicate how specific phonetic units are to be pronounced in certain circumstances. For example, a prosodic model may consider a phoneme's position in a syllable, a syllable's position in a word, a word's position in a sentence or phrase, neighboring phonetic units, etc. In the same manner as the language dictionary, a prosodic model with more information may result in higher quality speech output.

The output of the front end may include a sequence of phonetic units annotated with prosodic characteristics. The output of the front end may be referred to as a symbolic linguistic representation. This symbolic linguistic representation may be sent to the speech synthesis engine.

The speech synthesis engine may perform a process of converting speech into an audio waveform to output it to a user through the output unit 130. The speech synthesis engine may be configured to convert input text into high-quality natural-sounding speech in an efficient manner. Such high-quality speech may be configured to sound as much like a human speaker as possible.

The speech synthesis engine may perform speech synthesis using one or more different methods.

A unit selection engine matches the symbolic linguistic representation created by the front end against a recorded speech database. The unit selection engine matches the symbolic linguistic representation against spoken audio units in the speech database. Matching units are selected and concatenated together to form a speech output. Each unit includes an audio waveform corresponding with a phonetic unit, such as a short .wav file of the specific sound, along with a description of the various acoustic features associated with the .wav file (such as its pitch, energy, etc.), as well as other information, such as where the phonetic unit appears in a word, sentence, or phrase, the neighboring phonetic units, etc.

Using all the information in the unit database, the unit selection engine may match units to the input text to create a natural sounding waveform. The unit database may include multiple examples of phonetic units to provide the voice recognizing apparatus 10 with many different options for concatenating units into speech. One benefit of unit selection is that, depending on the size of the database, a natural sounding speech output may be generated. Moreover, the larger the unit database, the more likely the voice recognizing apparatus 10 will be able to construct natural sounding speech.

Another method of speech synthesis other than the above-described unit selection synthesis includes parametric synthesis. In parametric synthesis, synthesis parameters such as frequency, volume, and noise may be varied by a parametric synthesis engine, a digital signal processor, or other audio generation device to create an artificial speech waveform output.

Parametric synthesis may use an acoustic model and various statistical techniques to match a symbolic linguistic representation with desired output speech parameters. Parametric synthesis allows for processing of speech without a large-volume database associated with unit selection and also allows for accurate processing of speech at high speeds. Unit selection synthesis and parametric synthesis may be performed individually or combined together to produce speech audio output.

Parametric speech synthesis may be performed as follows. The processor 170 may include an acoustic model which may convert a symbolic linguistic representation into a synthetic acoustic waveform of text input based on audio signal manipulation. The acoustic model may include rules which may be used by the parametric synthesis engine to assign specific audio waveform parameters to input phonetic units and/or prosodic annotations. The rules may be used to calculate a score representing a likelihood that a particular audio output parameter(s) (such as frequency, volume, etc.) corresponds to the portion of the input symbolic linguistic representation from the front end.

The parametric synthesis engine may use a number of techniques to match speech to be synthesized with input phonetic units and/or prosodic annotations. One common technique is using Hidden Markov Models (HMMs). HMMs may be used to determine probabilities that audio output should match textual input. HMMs may be used to transition from parameters from the linguistic and acoustic space to the parameters to be used by a vocoder (a digital voice encoder) to artificially synthesize the desired speech.

The voice recognizing apparatus 10 may be configured with a phonetic unit database for use in unit selection. The phonetic unit database may be stored in the memory 140 or other storage component. The phonetic unit database may include recorded speech utterances. The speech utterances may be text corresponding to the utterances. The phonetic unit database may include recorded speech (in the form of audio waveforms, feature vectors, or other formats), which may occupy a significant amount of storage in the voice recognizing apparatus 10. The unit samples in the phonetic unit database may be classified in a variety of ways including by phonetic unit (phoneme, diphone, word, etc.), linguistic prosodic label, acoustic feature sequence, speaker identity, etc. The sample utterances may be used to create mathematical models corresponding to desired audio output for particular phonetic units.

When matching a symbolic linguistic representation, the speech synthesis engine may attempt to select a unit in the phonetic unit database that most closely matches the input text (including both phonetic units and prosodic annotations). Generally, the larger the phonetic unit database, the greater the number of unit samples that can be selected, thereby enabling accurate speech output.

The processor 170 may transmit audio waveforms containing speech output to the output unit 130 to output them to the user. The processor 170 may store the audio waveforms containing speech in the memory 140 in a number of different formats such as a series of feature vectors, uncompressed audio data, or compressed audio data. For example, the processor 170 may encode and/or compress speech output by an encoder/decoder prior to transmission. The encoder/decoder may encode and decode audio data, such as digitized audio data, feature vectors, etc. The functionality of the encoder/decoder may be located in a separate component, or may be executed by the processor 170.

The memory 149 may store other information for voice recognizing. The content of the memory 140 may be prepared for general voice recognizing or may be customized to include sounds and words that are likely to be used in a particular application. For example, for TTS processing by a global positioning system (GPS), the TTS storage may include customized speech specialized for positioning and navigation.

The memory 140 may be customized for an individual user based on his/her individualized desired speech output. For example, the user may prefer a speech output voice to be a specific gender, have a specific accent, be spoken at a specific speed, or have a distinct emotive quality (e.g., a happy voice). The speech synthesis engine may include specialized databases or models to account for such user preferences.

The voice recognizing apparatus 10 also may be configured to perform TTS processing in multiple languages. For each language, the processor 170 may include specially configured data, instructions, and/or components to synthesize speech in the desired language(s).

To improve performance, the processor 170 may revise/update the content of the memory 140 based on feedback about the results of TTS processing, thus enabling the processor 170 to improve voice recognizing beyond the capabilities provided in the training corpus.

With improvements in the processing capability of the voice recognizing apparatus 10, speech output can be produced by reflecting emotional attributes of input text. Alternatively, the voice recognizing apparatus 10 is capable of speech output by reflecting the user's intent (emotional information) who wrote the input text, even if the input text does not contain emotional attributes.

When building a model to be integrated with a TTS module that actually performs TTS processing, the TTS system may integrate the aforementioned various components and other components. In an example, the voice recognizing apparatus 10 may comprise a block for setting a speaker.

A speaker setting part may set a speaker for each character that appears in a script. The speaker setting part may be integrated with the processor 170 or integrated as part of the front end or speech synthesis engine. The speaker setting part allows text corresponding to multiple characters to be synthesized in a set speaker's voice by using metadata corresponding to the speaker's profile.

According to an embodiment of the present disclosure, the metadata may use a markup language, preferably, a speech synthesis markup language (SSML).

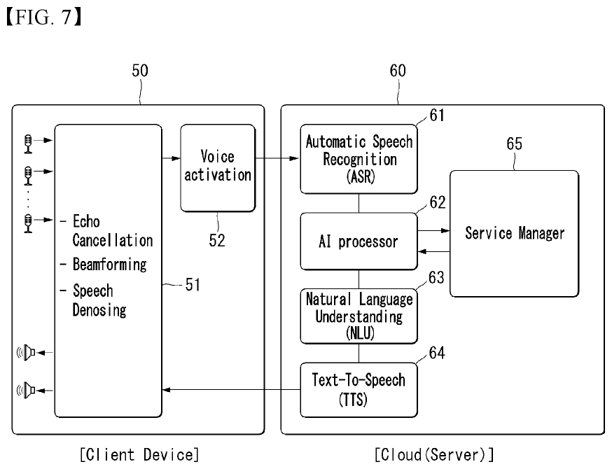

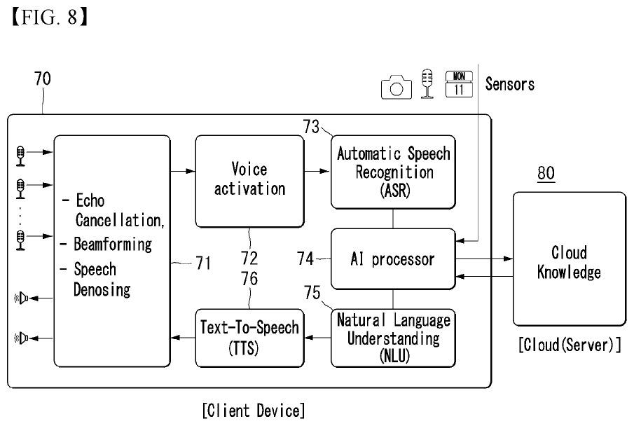

A speech processing process (voice recognition and speech output (TTS) process) performed in a device environment and/or a cloud environment or a server environment is described below with reference to FIGS. 7 and 8. In FIGS. 7 and 8, device environments 50 and 70 may be called a client device, and cloud environments 60 and 80 may be called a server. FIG. 7 illustrates an example in which the input of speech may be carried out in the device 50, but a process of processing the input speech and synthesizing the speech, that is, an overall operation of the speech processing is performed in the cloud environment 60. On the other hand, FIG. 8 illustrates an example of on-device processing in which the overall operation of the speech processing of processing the input speech and synthesizing the speech described above is carried out in the device 70.

FIG. 7 illustrates a schematic block diagram of a speech recognition device in an environment of a speech recognition system according to an embodiment of the present disclosure.

In an end-to-end speech UI environment, various components are required to process speech events. The sequence for processing the speech event performs speech signal acquisition and playback, speech pre-processing, voice activation, speech recognition, natural language processing, and finally a speech synthesis process in which the device responds to the user.

A client device 50 may include an input module. The input module may receive a user input from a user. For example, the input module may receive the user input from a connected external device (e.g., keyboard, headset). For example, the input module may include a touch screen. For example, the input module may include a hardware key located on a user terminal.

According to an embodiment, the input module may include at least one microphone capable of receiving a user's speech as a voice signal. The input module may include a speech input system, and may receive a user's speech as a voice signal through the speech input system. The at least one microphone may generate an input signal for audio input, thereby determining a digital input signal for the user's speech. According to an embodiment, a plurality of microphones may be implemented as an array. The array may be arranged in a geometric pattern, for example, a linear geometric form, a circular geometric form, or other configurations. For example, for a predetermined position, the array of four sensors may be separated by 90° and arranged in a circular pattern, in order to receive sound from four directions. In some implementations, the microphone may include spatially different arrays of sensors in data communication, including a networked array of sensors. The microphone may include omnidirectional, directional (e.g., shotgun microphone), and the like.

The client device 50 may include a pre-processing module 51 capable of pre-processing the user input (voice signals) received through the input module (e.g., microphone).

The pre-processing module 51 may remove an echo included in a user voice signal input through the microphone by including an adaptive echo canceller (AEC) function. The pre-processing module 51 may remove a background noise included in the user input by including a noise suppression (NS) function. The pre-processing module 51 may detect an end point of a user's voice and find a part in which the user's voice is present, by including an end-point detect (EPD) function. In addition, the pre-processing module 51 may adjust a volume of the user input to be suitable for recognizing and processing the user input by including an automatic gain control (AGC) function.

The client device 50 may include a voice activation module 52. The voice activation module 52 may recognize a wake-up command that recognizes a user's call (e.g., wake-up word). The voice activation module 52 may detect a predetermined keyword (e.g., Hi LG) from the user input that has undergone a pre-processing process. The voice activation module 52 may exist in a standby state to perform an always-on keyword detection function.

The client device 50 may transmit a user voice input to a cloud server. Automatic speech recognition (ASR) and natural language understanding (NLU) operations, which are core components for processing a user's speech, generally run in the cloud due to computing, storage, and power constraints, but are not necessarily limited thereto and may run in the client device 50.

The cloud may include a cloud device 60 that processes the user input transmitted from a client. The cloud device 60 may exist in the form of a server.

The cloud device 60 may include an automatic speech recognition (ASR) module 61, an artificial intelligence (AI) processor 62, a natural language understanding (NLU) module 63, a text-to-speech (TTS) module 64, and a service manager 65.

The ASR module 61 may convert the user voice input received from the client device 50 into text data.

The ASR module 61 includes a front-end speech pre-processor. The front-end speech pre-processor extracts representative features from a speech input. For example, the front-end speech pre-processor performs Fourier transformation on the speech input to extract spectral features that characterize the speech input as a sequence of representative multidimensional vectors. The ASR module 61 may include one or more speech recognition models (e.g., acoustic models and/or language models) and implement one or more speech recognition engines. Examples of the speech recognition models include hidden Markov models, Gaussian-Mixture Models, deep neural network models, n-gram language models, and other statistical models. Examples of the speech recognition engines include a dynamic time distortion-based engine and a weighted finite state transducer (WFST)-based engine. The one or more speech recognition models and the one or more speech recognition engines may be used to process the extracted representative features of the front-end speech pre-processor to generate intermediate recognition results (e.g., phonemes, phoneme strings, and sub-words) and ultimately text recognition results (e.g., words, word strings, or a sequence of tokens).

If the ASR module 61 generates recognition results including text strings (e.g., words, or a sequence of words, or a sequence of tokens), the recognition results are sent to the NLU module 63 for intention inference. In some examples, the ASR module 61 generates multiple candidate text representations of the speech input. Each candidate text representation is a sequence of words or tokens corresponding to the speech input.

The NLU module 63 may grasp a user intention by performing syntactic analysis or semantic analysis. The syntactic analysis may divide syntactic units (e.g., words, phrases, morphemes, etc.) and grasp what syntactic elements the divided units have. The semantic analysis may be performed using semantic matching, rule matching, or formula matching, etc. Hence, the NUL module 63 may acquire a domain, an intention, or a parameter necessary for expressing the intention by a user input.

The NLU module 63 may determine a user's intention and parameters using a mapping rule divided into the domain, the intention, and the parameter required to grasp the intention. For example, one domain (e.g., alarm) may include a plurality of intentions (e.g., alarm setting, alarm off), and one intention may include a plurality of parameters (e.g., time, number of repetitions, alarm sound, etc.). A plurality of rules may include, for example, one or more essential element parameters. The matching rule may be stored in a natural language understanding database.

The NLU module 63 grasps the meaning of words extracted from the user input by using linguistic features (e.g., syntactic elements) such as morphemes and phrases, and determines the user's intention by matching the meaning of the grasped word to a domain and an intention.

For example, the NLU module 63 may determine the user intention by calculating how many words extracted from the user input are included in each domain and intention. According to an embodiment, the NLU module 63 may determine a parameter of the user input using words that are the basis for grasping the intention.

According to an embodiment, the NLU module 63 may determine the user's intention using the natural language recognition database in which linguistic features for grasping the intention of the user input are stored.

In addition, according to an embodiment, the NLU module 63 may determine the user's intention using a personal language model (PLM). For example, the NLU module 63 may determine the user's intention using personalized information (e.g., contact list, music list, schedule information, social network information, etc.).

The personal language model may be stored, for example, in the natural language recognition database. According to an embodiment, the ASR module 61 as well as the NLU module 63 may recognize the user's voice by referring to the personal language model stored in the natural language recognition database.

The NLU module 63 may further include a natural language generation module (not shown). The natural language generation module may change designated information into the form of text. The information changed into the text form may be in the form of natural language speech. The designated information may include, for example, information about additional input, information guiding completion of an operation corresponding to the user input, or information guiding an additional input of the user, etc. The information changed into the text form may be transmitted to the client device and displayed on a display, or transmitted to a TTS module and changed to a voice form.

A speech synthesis module (TTS module) 64 may change text type information into voice type information. The TTS module 64 may receive the text type information from the natural language generation module of the NLU module 63 and change the text-type information into the voice type information to transmit it to the client device 50. The client device 50 may output the voice type information through the speaker.

The speech synthesis module 64 synthesizes a speech output based on a provided text. For example, the result generated by the automatic speech recognition (ASR) module 61 is in the form of a text string. The speech synthesis module 64 converts the text string into an audible speech output. The speech synthesis module 64 uses any suitable speech synthesis technique to generate speech output from texts, and this includes concatenative synthesis, unit selection synthesis, diphone synthesis, domain-specific synthesis, formant synthesis, articulatory synthesis, hidden Markov model (HMM)-based synthesis, and sinewave synthesis, but is not limited thereto.

In some examples, the speech synthesis module 64 is configured to synthesize individual words based on the phoneme string corresponding to the words. For example, the phoneme string is associated with a word in the generated text string. The phoneme string is stored in metadata associated with words. The speech synthesis module 64 is configured to directly process the phoneme string in the metadata to synthesize speech-type words.

Since the cloud environment generally has more processing power or resources than the client device, it is possible to acquire a speech output of higher quality than actual in client-side synthesis. However, the present disclosure is not limited to this, and it goes without saying that a speech synthesis process can be actually performed on the client device (see FIG. 8).

According to an embodiment of the present disclosure, the cloud environment may further include the AI processor 62. The AI processor 62 may be designed to perform at least some of the functions performed by the ASR module 61, the NLU module 63, and/or the TTS module 64 described above. In addition, the AI processor 62 may contribute to perform an independent function of each of the ASR module 61, the NLU module 63, and/or the TTS module 64.

The AI processor 62 may perform the above-described functions through deep learning. The deep learning represents data in a form (e.g., in case of an image, pixel information is expressed as a column vector) that the computer can understand when there is any data, and many studies (how to make better representation techniques and how to build a model to learn them) are being conducted to apply this to learning. As a result of these efforts, various deep learning techniques such as deep neural networks (DNN), convolutional deep neural networks (CNN), recurrent Boltzmann machine (RNN), restricted Boltzmann machine (RBM), deep belief networks (DBN), deep Q-network can be applied to fields such as computer vision, speech recognition, natural language processing, and voice/signal processing.

Currently, all major commercial speech recognition systems (MS Cortana, Skype translator, Google Now, Apple Siri, etc.) are based on deep learning techniques.

In particular, the AI processor 62 may perform various natural language processing including machine translation, emotion analysis, and information retrieval using deep artificial neural network structure in the field of natural language processing.

The cloud environment may include a service manager 65 capable of collecting various personalized information and supporting the function of the AI processor 62. The personalized information acquired through the service manager 65 may include at least one data (calendar application, messaging service, music application use, etc.) that the client device 50 uses through the cloud environment, at least one sensing data (camera, microphone, temperature, humidity, gyro sensor, C-V2X, pulse, ambient light, iris scan, etc.) that the client device 50 and/or the cloud device 60 collect, and off device data that is not directly related to the client device 50. For example, the personalized information may include maps, SMS, news, music, stock, weather, Wikipedia information.

The AI processor 62 is represented in a separate block to be distinguished from the ASR module 61, the NLU module 63, and the TTS module 64 for convenience of description, but the AI processor 62 may perform functions of at least a part or all of the modules 61, 62, and 64.

The AI processor 62 may perform at least a part of the function of the AI processors 21 and 261 described with reference to FIGS. 5 and 6.

FIG. 8 illustrates a schematic block diagram of a speech recognition device in an environment of a speech recognition system according to another embodiment of the present disclosure.

A client device 70 and a cloud environment 80 illustrated in FIG. 8 may correspond to the client device 50 and the cloud environment 60 illustrated in FIG. 7, except a difference in some configurations and functions. Hence, detailed functions of the corresponding block in FIG. 8 may refer to FIG. 7.

Referring to FIG. 8, the client device 70 may include a pre-processing module 71, a voice activation module 72, an ASR module 73, an AI processor 74, an NLU module 75, and a TTS module 76. In addition, the client device 70 may include an input module (at least one microphone) and at least one output module.

In addition, the cloud environment 80 may include a cloud knowledge that stores personalized information in the form of knowledge.

The function of each module illustrated in FIG. 8 may refer to FIG. 7. However, since the ASR module 73, the NLU module 75, and the TTS module 76 are included in the client device 70, communication with the cloud may not be required for speech processing such as speech recognition and speech synthesis. Hence, an instant and real-time speech processing operation is possible.

Each module illustrated in FIGS. 7 and 8 is merely an example for explaining a speech processing process, and may have more or fewer modules than the modules illustrated in FIGS. 7 and 8. It should also be noted that two or more modules may be combined or have different modules or different arrangements of modules. The various modules illustrated in FIGS. 7 and 8 may be implemented with software instructions, firmware, or a combination thereof for execution by one or more signal processing and/or on-demand integrated circuits, hardware, or one or more processors.

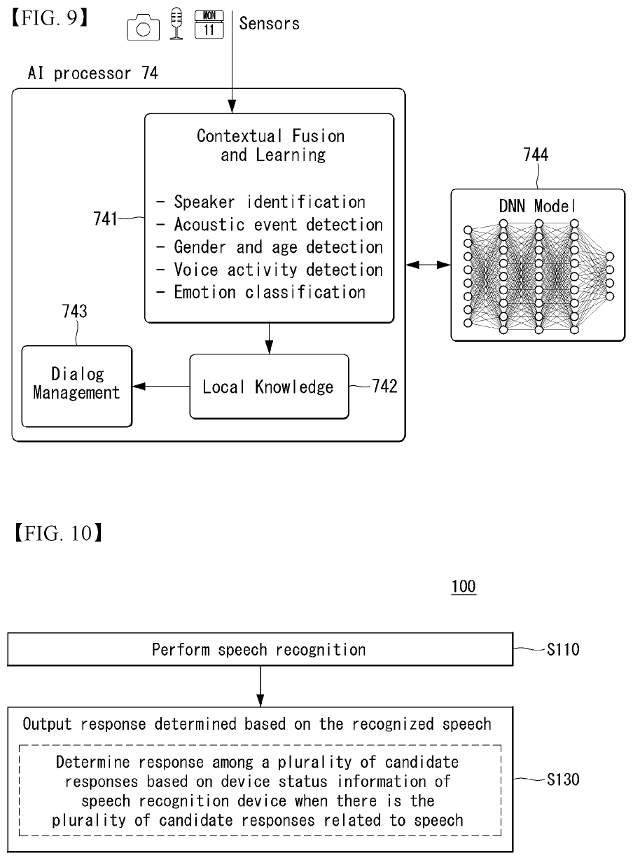

FIG. 9 illustrates a schematic block diagram of an AI processor capable of implementing speech recognition in accordance with an embodiment of the present disclosure.

Referring to FIG. 9, the AI processor 74 may support interactive operation with a user in addition to performing ASR operation, NLU operation, and TTS operation in the speech processing described with reference to FIGS. 7 and 8. Alternatively, the AI processor 74 may contribute to the NLU module 63 that performs an operation of clarifying, supplementing, or additionally defining information included in text expressions received from the ASR module 61 of FIG. 7 using context information.

The context information may include client device user preference, hardware and/or software states of the client device, various sensor information collected before, during, or immediately after user input, previous interactions (e.g., conversations) between the AI processor and the user. It goes without saying that the context information in the present disclosure is dynamic and varies depending on time, location, content of the conversation, and other factors.

The AI processor 74 may further include a contextual fusion and learning module 741, a local knowledge 742, and a dialog management 743.

The contextual fusion and learning module 741 may learn a user's intention based on at least one data. The at least one data may include at least one sensing data acquired in a client device or a cloud environment. The at least one data may include speaker identification, acoustic event detection, speaker's personal information (gender and age detection), voice activity detection (VAD), and emotion classification.

The speaker identification may refer to specifying a person, who speaks, in a conversation group registered by voice. The speaker identification may include a process of identifying a previously registered speaker or registering a new speaker. The acoustic event detection may detect a type of sound and a location of the sound by detecting the sound itself beyond a speech recognition technology. The voice activity detection (VAD) is a speech processing technique of detecting the presence or absence of human speech (voice) in an audio signal which may include music, noise or other sounds. According to an example, the AI processor 74 may determine whether speech is present from the input audio signal. According to an example, the AI processor 74 may distinguish between speech data and non-speech data using a deep neural network (DNN) model. In addition, the AI processor 74 may perform an emotion classification operation on speech data using the DNN model. Speech data may be classified into anger, boredom, fear, happiness, and sadness according to the emotion classification operation.

The context fusion and learning module 741 may include the DNN model to perform the operation described above, and may determine an intention of a user input based on sensing information collected from the DNN model and a client device or collected in a cloud environment.

The at least one data is merely an example, and any data that may be referenced to determine the user's intention in a voice processing process may be included. The at least one data may be acquired through the DNN model described above.

The AI processor 74 may include the local knowledge 742. The local knowledge 742 may include user data. The user data may include a user's preference, a user address, a user's initial setting language, a user's contact list, and the like. According to an example, the AI processor 74 may additionally define a user intention by supplementing information included in the user's voice input using specific information of the user. For example, in response to a user's request “Invite my friends to my birthday party”, the AI processor 74 may use the local knowledge 742 to determine who the “friends” are and when and where the “birthday party” will be given, without asking the user to provide more clear information.

The AI processor 74 may further include the dialog management 743. The AI processor 74 may provide a dialog interface to enable voice conversation with a user. The dialog interface may refer to a process of outputting a response to a user's voice input through a display or a speaker. A final result output via the dialog interface may be based on the ASR operation, the NLU operation, and the TTS operation described above.

I. Speech Recognition Method

FIG. 10 is a flow chart illustrating a speech recognition method according to an embodiment of the present disclosure.

As illustrated in FIG. 10, an intelligent speech recognition method of an intelligent speech recognition device according to an embodiment of the present disclosure includes a step S100 (S110 and S130) of FIG. 10 and is described in detail below.

The intelligent speech recognition device (the speech recognition device 10 of FIG. 6) first performs speech recognition for a user utterance, in S110.

For example, a processor (e.g., the processor 170 or the AI processor 261 of FIG. 6) of the intelligent speech recognition device may receive the user utterance through at least one microphone (e.g., the input unit 120 of FIG. 6). The processor may perform the speech recognition described with reference to FIGS. 7 to 9 with respect to the user utterance received through at least one microphone.

The processor may convert the user utterance into text data through the ASR module. Next, the processor may perform intention inference using a recognition result including text strings extracted from the user utterance through the natural language processing module. For example, the processor may generate a response related to the user utterance using the recognition result including text strings.

The response related to the user utterance may include one response. The response related to the user utterance may include a plurality of responses. That is, the response related to the user utterance may be related to a plurality of applications. The response related to the user utterance may be related to a plurality of motion statuses.

For example, the response related to the user utterance may be related to a music play application, and at the same time may also be related to a call incoming/outgoing application. Further, the response related to the user utterance may be related to a driving situation in which the speech recognition device is in a moving status, and at the same time may also be related to a business situation in which the speech recognition device is in a stationary state.

Next, the speech recognition device may output a response determined based on the recognized speech, in S130.

For example, when there are a plurality of candidate responses related to a speech, the processor may determine one response of the plurality of candidate responses based on device status information of the speech recognition device and output the determined one response. For example, the device status information may include information (or identification information) related to a type of an application executed at the time of receiving the user utterance. For example, the device status information may include motion status information of the speech recognition device at the time of receiving the user utterance.

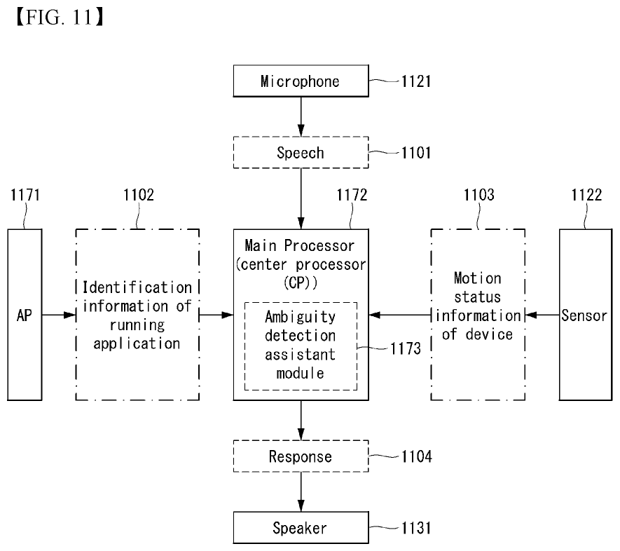

FIG. 11 illustrates data flow in a speech recognition device according to an embodiment of the present disclosure.

As illustrated in FIG. 11, a speech recognition device may include at least one processor (1171, 1172). For example, the at least one processor may include the processors 170 and 261 of FIG. 6. For example, the at least one processor may include an application processor (AP) 1171 for executing an application and a main processor (center processor (CP)) 1172 for controlling a plurality of modules of the speech recognition device. When an application is executed through the AP and the main processor requests identification information of the running application to the AP, the AP may transmit identification information 1102 of the currently running application to the main processor.

The speech recognition device may include a microphone 1121. The microphone may be one component of the input unit 120 of FIG. 1 or the input unit 120 of FIG. 6. For example, the main processor may recognize the user utterance received through the microphone in the form of data of speech 1101.

The speech recognition device may include a sensor 1122. The sensor may be one component of the sensing unit 140 of FIG. 1 or the input unit 120 of FIG. 6. The sensor may include a proximity sensor, an illuminance sensor, an acceleration sensor, a magnetic sensor, a gyro sensor, an inertial sensor, an RGB sensor, an IR sensor, a fingerprint sensor, an ultrasonic sensor, a light sensor, a microphone, lidar, radar, and the like. The main processor may acquire motion status information 1103 of the device (the speech recognition device) detected by the sensor.

Next, the main processor may generate one response 1104 related to the speech based on the speech, the identification information of the running application, and the motion status information of the device and may output the generated response in the form of sound through a speaker 1131. The speaker may be one component of the output unit 160 of FIG. 1 or the output unit 130 of FIG. 6. The main processor may output the generated response in the form of an image through the display (the output unit 160 of FIG. 1 or the output unit 130 of FIG. 6).

The main processor may include an ambiguity detection assistant module 1173 that determines whether the speech related response includes a plurality of responses.

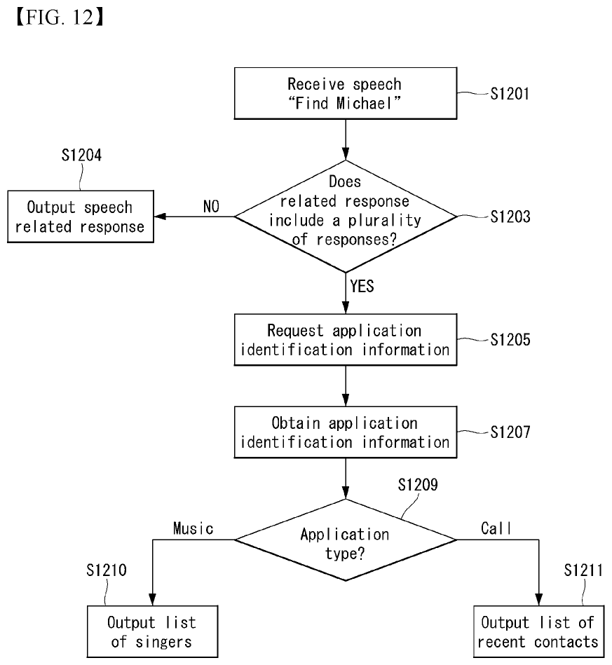

FIG. 12 is a flow chart illustrating a response output process depending on an application type according to an embodiment of the present disclosure.

As illustrated in FIG. 12, first, the microphone of the speech recognition device may receive a speech included in a user utterance “Find Michael”, in S1201.

Next, the main processor of the speech recognition device may determine whether a response related to the speech “Find Michael” includes a plurality of responses, in S1203.

If the response related to the speech includes one response as a result of determination, the main processor may output a speech related response, in S1204.

If the response related to the speech includes a plurality of responses as a result of determination, the main processor may request identification information of a currently running application to an application processor, in S1205.

Next, the main processor may obtain the application identification information from the application processor in response to the request, in S1207.

Next, the main processor may determine a type of the application based on the application identification information, S1209.

If the currently running application is a music play application as a result of determination, the main processor may determine that the speech “Find Michael” includes an intention to let the user know a list of singers named “Michael” in the music play application, and may output the list of singers named “Michael” through the music play application, in S1210.

If the currently running application is a call incoming/outgoing application as a result of determination, the main processor may determine that the speech “Find Michael” includes an intention to let the user know a list of recent contacts named “Michael” in the call incoming/outgoing application, and may output the list of recent contacts named “Michael” through the call incoming/outgoing application, in S1211.

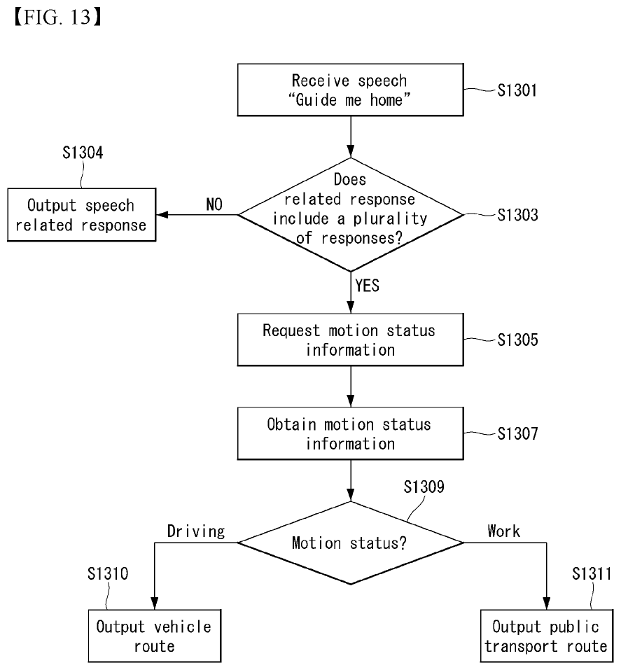

FIG. 13 is a flow chart illustrating a response output process depending on device motion status information according to an embodiment of the present disclosure.

As illustrated in FIG. 13, first, the microphone of the speech recognition device may receive a speech included in a user utterance “Guide me home”, in S1301.

Next, the main processor of the speech recognition device may determine whether a response related to the speech “Guide me home” includes a plurality of responses, in S1303.

If the response related to the speech includes one response as a result of determination, the main processor may output a speech related response, in S1304.

If the response related to the speech includes a plurality of responses as a result of determination, the main processor may request current motion status information of the speech recognition device to a sensing unit, in S1305.

Next, the main processor may obtain the motion status information from the sensing unit in response to the request, in S1307.

Next, the main processor may determine a current motion status of the device based on the motion status information, S1309.

If the current motion status of the device is dynamic driving as a result of determination, the main processor may determine that the speech “Guide me home” includes an intention to let the user know a vehicle route to the home in a vehicle route guidance application (or navigation application), and may output the vehicle route to the home through the vehicle route guidance application, in S1310.

If the current motion status of the device is static working as a result of determination, the main processor may determine that the speech “Guide me home” includes an intention to let the user know a public transport route to the home in a public transport application, and may output the public transport route to the home in the public transport application, in S1311.

J. Summary of Embodiments

Embodiment 1: an intelligent speech recognition method comprises recognizing an utterance of a user; and outputting a response determined based on the recognized utterance, wherein based on there being a plurality of candidate responses related to the utterance, the response is determined among the plurality of candidate responses based on device status information of a speech recognition device.

Embodiment 2: according to the embodiment 1, outputting the response may comprise determining whether there are the plurality of candidate responses related to the utterance, and based on there being the plurality of candidate responses related to the utterance, determining one response of the plurality of candidate responses based on the device status information of the speech recognition device, and determining whether there are the plurality of candidate responses may comprise determining whether a sentence included in the utterance is able to be processed in a plurality of applications, or the utterance is able to be processed in a plurality of motion statuses of the speech recognition device.

Embodiment 3: according to the embodiment 1, the device status information may include application identification information executed in the speech recognition device.

Embodiment 4: according to the embodiment 1, the device status information may include motion status information of the speech recognition device.

Embodiment 5: according to the embodiment 1, outputting the response may comprise determining, as the response to be output, a first candidate response with a highest relation to the device status information of the speech recognition device among the plurality of candidate responses, and based on a specific feedback for the first candidate response being obtained from the user, determining, as the response to be output, a second candidate response with a highest relation to the device status information of the speech recognition device among remaining responses excluding the first candidate response from the plurality of candidate responses.

Embodiment 6: an intelligent speech recognition device comprises at least one sensor; at least one speaker; at least one microphone; and a processor configured to recognize an utterance of a user obtained through the at least one microphone and output a response determined based on the recognized utterance through the at least one speaker, wherein the processor is configured to, based on there being a plurality of candidate responses related to the utterance, determine the response among the plurality of candidate responses based on device status information of the speech recognition device.

Embodiment 7: according to the embodiment 6, the processor may be further configured to determine whether there are the plurality of candidate responses related to the utterance, based on there being the plurality of candidate responses related to the utterance, determine one response of the plurality of candidate responses based on the device status information of the speech recognition device, and determine whether a sentence included in the utterance is able to be processed in a plurality of applications, or the utterance is able to be processed in a plurality of motion statuses of the speech recognition device.

Embodiment 8: according to the embodiment 6, the device status information may include application identification information executed in the speech recognition device.

Embodiment 9: according to the embodiment 6, the device status information may include motion status information of the speech recognition device obtained through the at least one sensor.

Embodiment 10: according to the embodiment 6, the processor may be further configured to determine, as the response to be output, a first candidate response with a highest relation to the device status information of the speech recognition device among the plurality of candidate responses, and based on a specific feedback for the first candidate response being obtained from the user, determine, as the response to be output, a second candidate response with a highest relation to the device status information of the speech recognition device among remaining responses excluding the first candidate response from the plurality of candidate responses.

The present disclosure described above can be implemented using computer-readable media with programs recorded thereon for execution. The computer-readable media include all kinds of recording devices capable of storing data that is readable by a computer system. Examples of the computer-readable media include hard disk drive (HDD), solid state disk (SSD), silicon disk drive (SDD), ROM, RAM, CD-ROM, a magnetic tape, a floppy disk, and an optical data storage device, other types of storage media presented herein, etc. If desired, the computer-readable media may be implemented in the form of a carrier wave (e.g., transmission over Internet). Accordingly, the detailed description should not be construed as limiting in all aspects and should be considered as illustrative. The scope of the present disclosure should be determined by rational interpretation of the appended claims, and all modifications within an equivalent scope of the present disclosure are included in the scope of the present disclosure.

1-10. (canceled)

11. A speech recognition method in an intelligent speech recognition device, comprising:
recognizing an utterance of a user; and
outputting a response determined based on the recognized utterance,
wherein based on a determination that a plurality of candidate responses relate to the recognized utterance, the outputted response is determined from among the plurality of candidate responses according to device status information of the intelligent speech recognition device.

12. The speech recognition method of claim 11, wherein the determination of whether there are the plurality of candidate responses comprises:
determining whether a sentence included in the recognized utterance is capable of being processed in a plurality of applications or related to a plurality of motion statuses of the intelligent speech recognition device.

13. The speech recognition method of claim 11, wherein the device status information comprises application identification information executed in the intelligent speech recognition device.

14. The speech recognition method of claim 11, wherein the device status information comprises motion status information of the intelligent speech recognition device.

15. The speech recognition method of claim 11, wherein method further comprises:
determining, as the response to be output, a first candidate response with a highest relation to the device status information of the intelligent speech recognition device among the plurality of candidate responses; and
based on a specific feedback for the first candidate response being obtained from the user, determining, as the response to be output, a second candidate response with a highest relation to the device status information of the intelligent speech recognition device among remaining responses excluding the first candidate response from the plurality of candidate responses.

16. An intelligent speech recognition device, comprising:
at least one sensor;
at least one speaker;
at least one microphone; and
a processor configured to:
recognize an utterance of a user obtained through the at least one microphone, and
output a response determined based on the recognized utterance through the at least one speaker,
wherein based on a determination that a plurality of candidate responses relate to the recognized utterance, the outputted response is determined from among the plurality of candidate responses according to device status information of the intelligent speech recognition device.

17. The intelligent speech recognition device of claim 16, wherein the determination of whether there are a plurality of candidate responses comprises:
determining whether a sentence included in the utterance is capable of being processed in a plurality of applications or related to a plurality of motion statuses of the intelligent speech recognition device.

18. The intelligent speech recognition device of claim 16, wherein the device status information includes application identification information executed in the intelligent speech recognition device.

19. The intelligent speech recognition device of claim 16, wherein the device status information includes motion status information of the intelligent speech recognition device obtained through the at least one sensor.

20. The intelligent speech recognition device of claim 16, wherein the processor is further configured to:
determine, as the response to be output, a first candidate response with a highest relation to the device status information of the intelligent speech recognition device among the plurality of candidate responses; and
based on a specific feedback for the first candidate response being obtained from the user, determine, as the response to be output, a second candidate response with a highest relation to the device status information of the intelligent speech recognition device among remaining responses excluding the first candidate response from the plurality of candidate responses.
